(19) United States
(12) Patent Application Publication
(10) Pub. No.: US 2015/0286766 A1
(43) Pub. Date: Oct. 8, 2015

(54) METHOD AND SYSTEM FOR AUTOMATED DESIGN OF AN INTEGRATED CIRCUIT USING CONFIGURABLE CELLS

(71) Applicants: Kunwar Singh, New Delhi (IN); Satish Chandra Tiwari, Greater Noida (IN); Maneesha Gupta, New Delhi (IN)

(72) Inventors: Kunwar Singh, New Delhi (IN); Satish Chandra Tiwari, Greater Noida (IN); Maneesha Gupta, New Delhi (IN)

(73) Assignee: Satish Chandra Tiwari, Greater Noida (IN)

(21) Appl. No.: 14/438,179

(22) PCT Filed: Oct. 25, 2013
(86) PCT No.: PCT/IB2013/059646

§ 371 Date: Apr. 23, 2015

(30) Foreign Application Priority Data
Oct. 25, 2012 (IN) 3282/DEL/2012

(51) Int. Cl. G06F 17/50

(52) U.S. Cl. CPC G06F 17/5072

(57) ABSTRACT

According to the present disclosure, the present invention discloses a methodology wherein the integrated circuit (IC) design process is independent of a pre-existing standard cell library with fixed or static driving strengths. The present invention utilizes a completely automated process for IC design utilizing a neural network based configurable cell library which generates design specific standard cells with desired driving strengths on the run. The driving strengths of the design specific standard cells are determined based on the constraints of the target IC design.

### TECHNICAL FIELD

The present disclosure relates to the field of integrated circuits and, more particularly, to synthesis methodologies for integrated circuits.

### BACKGROUND

The ever increasing demand for portable electronic devices has led to tremendous growth of the VLSI (Very Large Scale Integrated Circuit) industry and in particular, ASIC (Application Specific Integrated Circuit) designs. However, relatively large number of transistors included in such design makes it difficult for designers to design each transistor and its interconnection to other transistors. Therefore, integrated circuit designers specify the operation of the integrated circuit using a high level design language (HDL) such as Verilog or VHDL. The description of the integrated circuit is typically a register-transfer level (RTL) description. An RTL description comprises multiple storage devices (e.g. the “registers”) which store a current state of the integrated circuit, and a set of logical instructions defining a next state of the integrated circuit.

The process of compiling an RTL description includes a first compiling step, referred to as synthesis, which converts the RTL description into a list of cells and interconnection there between. The list of cells interconnected as specified by the synthesis tool implements the logical next state instructions of the RTL description. The cells available to the synthesis tool are provided to the synthesis tool in the form of a cell library comprising multiple cells. Each cell has a set of attributes defining the cell's logical, electrical, and physical properties. One cell attribute is a logical function (such as AND, OR, NAND, NOR, etc., or a complex logical function implementing an equation of basic logical functions) between one or more input pins and one or more output pins of the cell. Another, cell attribute is timing information regarding the delay between a signal arriving at a particular input to the cell and an output signal from the cell reacting to the input signal. Each cell is associated with a corresponding circuit including a set of transistors arranged for placement upon an integrated circuit and interconnections between the transistors. The area occupied by the corresponding circuit is a third cell attribute included in the cell library. Furthermore, the timing information referred to above is derived from the circuit and from parameters defined for semiconductor fabrication process in which the circuit is to be implemented.

The synthesis tool uses logical functions of the cells in the library to realize logical next state instructions defined in the RTL description. Additionally, provided to the synthesis tool, is a set of constraints for the design, including a maximum desired time and maximum area for the integrated circuit. The synthesis tool attempts to realize the RTL description using the cell library within the time and area constraints, as well as any other constraints provided to the synthesis tool.

The RTL description of the integrated circuit is typically synthesized multiple times during the design of the integrated circuit. The early synthesis results tend to include a number of logic paths (i.e. interconnected levels of cells between two storage devices) which do not meet the design constraints. Integrated circuit designers analyze the results of the earlier synthesis runs and change the integrated circuit design and/or optimize the RTL description to improve the results of later synthesis runs. Once a design has substantially achieved the design constraints, a second compiling step is performed. The lists of cells corresponding to the integrated circuit and interconnects are “laid out” (i.e. placed within the confines of the desired integrated circuit dimensions) and the wiring between the partitions is routed through the wiring layers. Once the layout is completed, an extraction of the capacitance for the interconnect can be performed, and a final timing analysis including the interconnect delay and delays for the cells is performed to verify that the integrated circuit meets the design goals for the integrated circuit.

A typical cell library includes multiple cells implementing the same basic logical function (e.g. AND, OR. NAND, NOR, etc.) or complex logical function. The multiple cells correspond to different circuits. The number and configuration of the transistors may vary between the circuits corresponding to each of the cells. Alternatively, the “drive strength” may be varied between different circuits having the same number and configuration of transistors. The drive strength is a measure of the circuits ability to charge/discharge a largely capacitive load (e.g. the input pins of other cells plus the wiring there between). High drive strength indicates the ability to charge/discharge a large load quickly, while low drive strength indicates a longer time period for charging/discharging a large load. The drive strength may be characterized by an output resistance for the cell. Typically, a circuit having a higher drive strength occupies more area than an equivalent circuit having a lower drive strength (the transistors are made larger to increase the drive strength, for example).

The synthesis tool uses the multiple cells corresponding to a given logical function to realize the RTL description within the following three strict constraints (i) the netlist must incorporate the desired logic functionality (ii) the netlist must meet system timing constraints must be met (iii) the netlist must occupy minimal standard cell area.

If the obtained RTL netlist violates any of the above mentioned constraints, the designer can further improve the HDL code and if the violations still persist, full custom designing for some specific part or the entire obtained RTL netlist is needed. The process might involve several iterations but designing at full custom level provides freedom to a designer to implement standard cells of specific driving strengths (which might be fractional i.e. 1.732X as well). This methodology substantially increases time to market eliminating the very essence of ASIC designing. To limit this problem to some extent, standard cell library is being continuously loaded with more number of standard cells having different driving strengths. However, it is not possible to have standard cells of all the driving strengths being embedded in the library. In fact, a heavily loaded cell library leads to undesirable increase in logic synthesis run time.

Furthermore, it is important to note that the above synthesis criterion attempts to minimize total standard cell area under specified timing constraints but not the total power dissipation. Moreover, present day tools might satisfy the timing constraints but in the process, area and power are significantly compromised. For example, if standard cell of 1.7X driving strength is required to satisfy the specified timing constraint and standard cells of 1X and 2X driving strength are available then the synthesis tool chooses the 2X cell which although faster leads to increased area and power dissipation because a standard cell with greater driving strength is composed of larger size transistors. The main reason to compromise with area and power is the underlying problem of standard cells in the library which are large in number but static in terms of driving strength. Hence, a synthesis tool is required based on a synthesis methodology that optimizes the system for highest frequency at minimum power and optimal area.

FIG. 1 illustrates a flow chart showing conventional ASIC design flow according to a prior art. The specification of a circuit design is specified in terms of design constraints in step 101. At step 102, the description is expressed in a Hardware Description Language (HDL) in a manner that is largely independent of the physical design of the IC function. Verilog or VHDL) are examples of a suitable language. Using the HDL description, a gate-level representation (netlist) is generated from the HDL description using logic synthesis in step 103. The gate-level representation of the IC is expanded i.e. placement and routing of the gate level netlist is performed using a predefined library of standard cell in step 104. An automated circuit modeling and capture application, such as for example, SPICE can be used to evaluate the transistor-level representation of the IC in step 105 and 106. The next step in the top-down approach is the layout of the described and designed IC at step 107. Further, it is determined in step 108 and 109 whether the functional blocks meet the specifications of the target IC design. If it is determined that the functional blocks satisfactorily meet the specifications for the IC design, then a layout description for the functional circuit block is generated at step 110. The layout-level description is preferably in a format adept at describing graphical representations, such as, for example, Graphic Design System II (GDSII).

Although the top-down hierarchical approach theoretically provides excellent IC design process control, the IC design process rarely progresses in a strict top-down manner. In practice, both the top-down and a bottom-up design flow is used because the IC design process often involves iterations progressing from top-down and bottom-up in an attempt to meet the IC specifications. For example, if a system designer specifies architecture (i.e., a top-level description) without an accurate estimate of the corresponding circuit area (i.e., a bottom level description), then it is highly probable that the resultant IC layout will exceed the maximum area permitted for the IC.

In this example, in order to meet the allowable maximum area constraint, certain functions of the design may have to be removed from the design (e.g., a repartitioning of the system) and the design process repeated until an IC design having an acceptable circuit area is achieved.

As mentioned above, the manual, full custom approach to designing ICs is prone to error. A hierarchical, manual design process is especially vulnerable to the introduction of errors at the layout stage where the detailed information describing the design is the greatest and thus, most complex.

For very complex yet high-volume selling circuits such as microprocessors, there is a need to efficiently use every square micron of the silicon comprising the IC in order to achieve the maximum yield at the minimum cost. In such cases, manual design processes are often applied to major parts of the circuit to achieve maximum use of the IC silicon.

FIG. 2 illustrates a fully customized IC design process flow according to a prior art. The full-custom methodology starts with a system/IC function description at step 201. At step 202, the description is expressed in a Hardware Description Language (HDL). The IC design is then partitioned into functional blocks in step 203. As shown in steps 203 a-203 e, the partitioned blocks are further described and implemented using a top-down hierarchal approach in step 203a. The blocks are described in step 203 b using manual or semiautomatic tools to capture and describe the transistor-level representation of the functional blocks. This design step typically includes pre-layout transistor-level simulation using simulators such as SPICE. This is typically a labor-intensive and time-consuming manual process. Beyond this stage, some design tool assistance is usually employed to complete the system description. Layout design tools or other automatic/semi-automatic tools for implementing transistor layouts based on a transistor netlist representation may be used to complete the transistor-level description of the system.

At step 203 c, the functional blocks are characterized to verify and characterize the implemented design in terms of conventional metrics, such as layout design rules, delay, power, signal integrity, testability, area, signal, power dissipation, reliability, testability, and other verifiable constraints. It is determined in step 203 d whether the functional blocks meet the specifications of the target IC design. If it is determined that the functional blocks satisfactorily meet the specifications for the IC design, then a layout description for the functional circuit block is generated at step 203 e. The process typically iterates until the design constraints are satisfied. The verification and characterization step is usually invoked in order to accurately understand the behavior of the implemented circuit (especially timing behavior) and to provide assurances that the design can be manufactured reliably.

The IC design is verified and it is determined whether the disclosed design meets the specifications for the design at step 204. As shown, the design process can iterate until the resultant design meets the required specifications. Once the IC design meets the specifications, the final layout of the IC design can commence at step 205 and 206.

Full-custom design processes are particularly useful where portions of the target IC design repeat often, and for blocks that are in the critically important portions of the design. Under such circumstances, the time and expense required for a full, custom design are justified by the high quality results of full custom IC design. For example, full, custom designs are used for memory cell designs, arithmetic block/datapath designs, etc.

Standard-cell based IC design methodologies use low functionality circuit building blocks or cells. Standard-cell based design methodologies typically use a library of pre-existing cells or elements as the building blocks of an IC in the IC design process. In the IC design processes using standard-cells, the standard cells are interconnected to form larger building blocks for use in the overall IC design. The assembly of larger building blocks is repeated until the entire IC design is completely captured by interconnected standard cells.

Standard-cell based IC design processes are used in full or partial automation of IC designs since the standard cells used to describe the IC design are pre-determined entities having known characteristics. Each standard-cell may have multiple implementations to provide different, yet still pre-defined, characteristics to hopefully suit the IC designer's specific needs. Characterization of each cell is performed by the standard-cell designer/manufacturer in terms of delay time versus load capacitance, and other parameters so that IC designers know the standard-cell's characteristics.

To complete the IC design process using standard-cells requires a complete mask set for the target design. This requirement makes this design process more expensive than other pre-fabricated design processes (e.g., gate arrays).

Hence, there is a need to have a system and method that can overcome the above stated problems and provides an automated designing of an integrated circuit.

### SUMMARY

The following presents a simplified summary of the subject matter in order to provide a basic understanding of some aspects of subject matter embodiments. This summary is not an extensive overview of the subject matter. It is not intended to identify key/critical elements of the embodiments or to delineate the scope of the subject matter.

Its sole purpose is to present some concepts of the subject matter in a simplified form as a prelude to the more detailed description that is presented later.

It is therefore a primary objective of this disclosure to provide a method and an associated system that provides a novel synthesis methodology based on standard cells which are dynamically configurable in nature in terms of driving strength or any other circuit parameters thereof.

According to the present invention, the synthesis tool is provided with an optimized methodology to pick up standard cells which can adjust their driving strengths dynamically (on the run) to satisfy the timing, area and power constraints.

According to the preferred embodiment of the present invention, a method for designing an integrated circuit, the method comprising (a) creating an optimized cell library, wherein said cell library comprising a configurable cell for implementing a logic function; wherein said configurable cell is capable of implementing plurality of standard cells; wherein said configurable cell is characterized with a drive strength which varies with the input capacitance and/or output load capacitance of the circuit; wherein said drive strength is generated dynamically by evaluating a set of basic attributes of said cell from a set of input values derived from design goals for said integrated circuit; (b) generating an integrated circuit design layout based on a set of output circuit parameters derived from the drive strength of said cell.

According to the another embodiment of the present invention, a system (500) for designing an integrated circuit comprising (a) a digital hardware description processor (501), a memory (502) coupled to said processor (501), and a user input interface (503) coupled to said processor (501), said hardware description processor being operative to create an optimized cell library, wherein said cell library comprising a configurable cell for implementing a logic function; wherein said configurable cell is capable of implementing plurality of standard cells; wherein said configurable cell is characterized with a drive strength which varies with the input capacitance and/or output load capacitance of the circuit; wherein said drive strength is generated dynamically by evaluating a set of basic attributes of said cell from a set of input values derived from design goals for said integrated circuit; b) a layout generator (504) coupled to said digital hardware description to generate an integrated circuit design layout based on a set of output circuit parameters derived from the drive strength of said cell.

These and other objects, embodiments and advantages of the present disclosure will become readily apparent to those skilled in the art from the following detailed description of the embodiments having reference to the attached figures, the disclosure not being limited to any particular embodiments disclosed.

### BRIEF DESCRIPTION OF THE DRAWINGS

For a better understanding of the embodiments of the systems and methods described herein, and to show more clearly how they may be carried into effect, reference will now be made, by way of example, to the accompanying drawings, wherein:

FIG. 1 illustrates a flow chart showing conventional ASIC design flow according to a prior art.

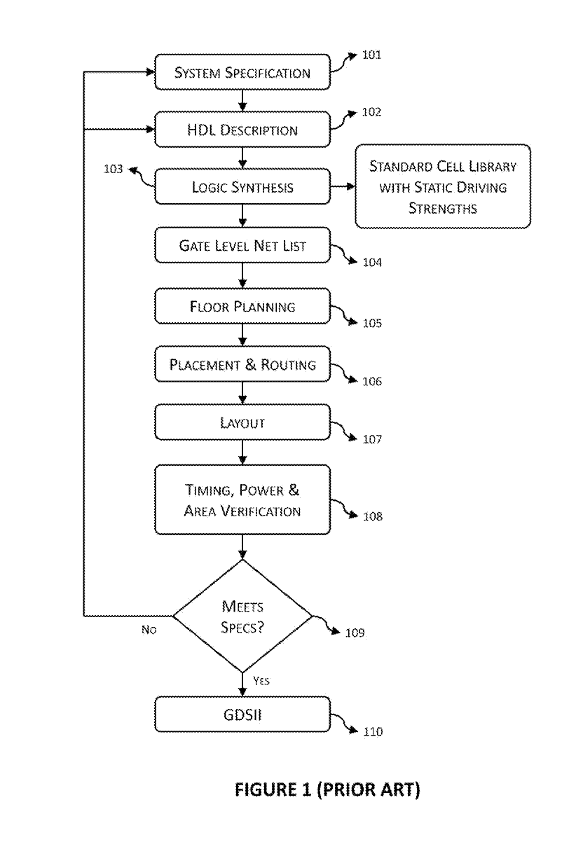

FIG. 2 illustrates a fully customized IC design process flow according to a prior art.

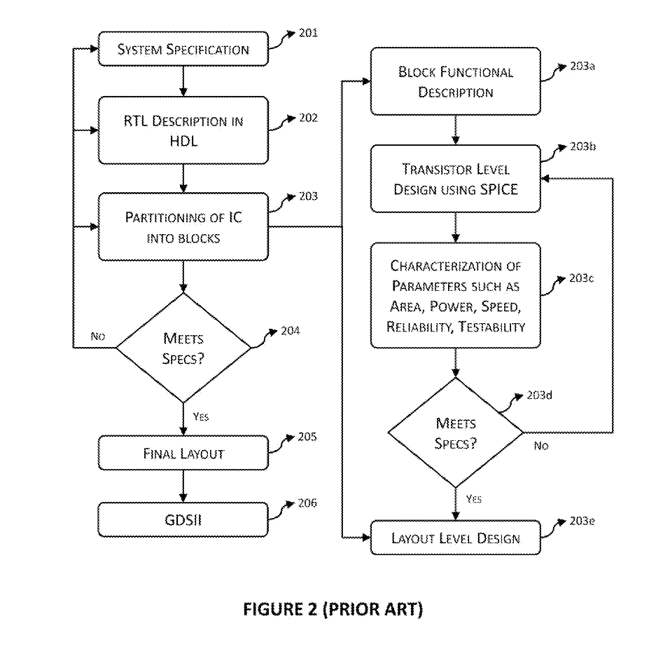

FIG. 3 illustrates a preferred embodiment of the integrated circuit design in accordance with the present invention.

FIG. 4 illustrates the methodology for designing a neural network based configurable cell.

FIG. 5 illustrates a system configuration in accordance with the present invention

### DESCRIPTION

Exemplary embodiments now will be described with reference to the accompanying drawings. The disclosure may, however, be embodied in many different forms and should not be construed as limited to the embodiments set forth herein; rather, these embodiments are provided so that this disclosure will be thorough and complete, and will fully convey its scope to those skilled in the art. The terminology used in the detailed description of the particular exemplary embodiments illustrated in the accompanying drawings is not intended to be limiting. In the drawings, like numbers refer to like elements.

The specification may refer to “an”, “one” or “some” embodiment(s) in several locations. This does not necessarily imply that each such reference is to the same embodiment(s), or that the feature only applies to a single embodiment. Single features of different embodiments may also be combined to provide other embodiments.

As used herein, the singular forms “a”, “an” and “the” are intended to include the plural forms as well, unless expressly stated otherwise. It will be further understood that the terms “includes”, “comprises”, “including” and/or “comprising” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include operatively connected or coupled. As used herein, the term “and/or” includes any and all combinations and arrangements of one or more of the associated listed items.

Unless otherwise defined, all terms (including technical and scientific terms) used herein have the same meaning as commonly understood by one of ordinary skill in the art to which this disclosure pertains. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The figures depict a simplified structure only showing some elements and functional entities, all being logical units whose implementation may differ from what is shown. The connections shown are logical connections; the actual physical connections may be different. It is apparent to a person skilled in the art that the structure may also comprise other functions and structures.

Also, all logical units described and depicted in the figures include the software and/or hardware components required for the unit to function. Further, each unit may comprise within itself one or more components which are implicitly understood. These components may be operatively coupled to each other and be configured to communicate with each other to perform the function of the said unit.

The features provided by the disclosed system in the present disclosure, may be accessed remotely, in one or more embodiments, and/or through an online service provider. Such types of online service providers operates and maintains the computing systems and environment, such as server system and architectures, that promote the delivery of portable electronic documents in a communication network. Typically, server architecture includes the infrastructure (e.g. hardware, software, and communication lines) that offers online services.

The detailed description follows in parts to terms of processes and symbolic representations of operations performed by conventional computers, including computer components. For the purpose of this disclosure, a computer may be any microprocessor or processor (hereinafter referred to as processor) controlled device such as, by way of example, personal computers, workstations, servers, clients, minicomputers, main-frame computers, laptop computers, a network of one or more computers, mobile computers, portable computers, handheld computers, palm top computers, set-top boxes for a TV, interactive televisions, interactive kiosks, personal digital assistants, interactive wireless devices, mobile browsers, or any combination thereof.

For the most part, the operations described herein are operations performed by a computer or a machine in conjunction with a human operator or user that interacts with the computer or the machine. The programs, modules, processes, methods, and the like, described herein are but an exemplary implementation and are not related, or limited, to any particular computer, apparatus, or computer language. Rather, various types of general purpose computing machines or devices may be used with programs constructed in accordance with the teachings described herein.

It would be well appreciated by persons skilled in the art that the term “module” and “unit” can be interchangeably used in the present disclosure.

It is noted that in order to facilitate manufacturing, layout and interconnections between standard-cells, are typically designed with a fixed height, or a multiple of the fixed height. The width of the assembled standard cells can vary to accommodate various target ICs. In modern standard-cell designs, connections are routed within the cell (i.e., intracell), between cells (i.e., intercell), and over cells (i.e., over-the-cell). Sophisticated routing algorithms and applications are used to accomplish the routing of the cells.

The problems related to automated IC design processes, namely slow timing, timing convergence, excessive die area and power consumption etc. can be attributed to the fact that the driving strengths of the standard cells is static in nature and is highly specific to individual IC designs. For e.g., in order to satisfy timing constraints at different levels of design flow, either buffers are inserted or standard cells with larger driving strengths are picked leading to both excessive area and power dissipation.

Although delay is mathematically related to transistor sizes through logical effort theory, however there is no accurate mathematical expression for estimating the power of a circuit based on transistor widths. It is extremely difficult to derive mathematical expressions for leakage power and delays below 100 nm. So automation has been done using (artificial intelligence) neural networks.

However, the present invention discloses a synthesis methodology wherein the IC design process is independent of a pre-existing standard cell library with fixed or static driving strengths. The present invention utilizes a completely automated process for IC design utilizing a neural network based standard cell library which generates design specific standard cells with desired driving strengths on the run (dynamically). The driving strengths of the design specific standard cells is determined based on the constraints of the target IC design.

The present invention discloses an automated IC design methodology with several advantages over the conventional ASIC design approach. Moreover, the disclosed methodology eliminates the wide gap between the current generation ASIC design process and the full custom design approach to a great extent. Due to availability of standard cells on demand, in accordance with the IC design constraints, the target IC can be optimized within a three dimensional design space viz. area, performance and power leading to automated optimization with minimum power(energy)-delay-area product (PDAP).

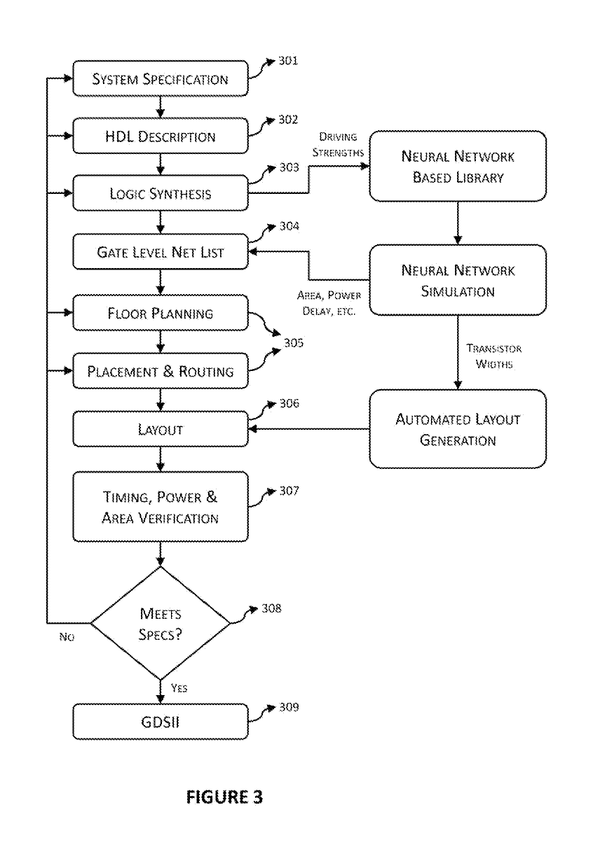

FIG. 3 illustrates a preferred embodiment of the integrated circuit design in accordance with the present invention. From an ASIC design point of view, a typical design flow includes logical mapping and technological mapping with design constraints. The task is accomplished based on a pre-defined library of standard cells with static driving strengths. However, the methodology is capable of trading off one design parameter for the other and hence optimizing the design in a three dimensional design space using dynamic driving strength. According to the disclosed methodology, in step 301, the system timing, power and area constraints are specified at the top level of the hierarchy. In the next step 302, RTL description of the design is encoded using HDL languages like VHDL, Verilog or languages like System C or System Verilog. The RTL code is converted into a gate level netlist by the synthesis tool in step 303 and 304. However, the synthesis tool in order to satisfy timing constraints generates the required driving strengths of standard cells. In the case of conventional ASIC flow the driving strengths produced by the synthesis tool are rounded off to the nearest integer if they are in fractions for e.g., 1.2X is rounded off to 1X (if standard cells with 1X and 2X driving strengths are available) and 6.2X is rounded off to 8X (if standard cells with 4X and 8X) driving strengths are available. In the first case, the performance is compromised whereas both area and power are compromised in the second case. One of the most important requirements thus is to produce standard cells with dynamic driving strengths. This is accomplished by utilizing a neural network based standard cell library in step 304. The neural network based library accepts driving strength as input and generates corresponding area, power and delay etc. to be utilized to implement gate level netlist to satisfy specified design constraints. A set of transistor widths belonging to the targeted standard cell as output is also generated. In step 305, floor planning, placement and routing is performed based on the information available in the previous stages. The transistor widths are accepted as input by a semi-automatic/automatic layout generating tool such as ‘Cellerity’ which generates the corresponding layout based on the transistor level netlist in step 306. The design at layout level is then optimized for minimal area using placement and routing algorithms or manually by the designer in step 307. Further, in step 308 it is determined whether the functional blocks meet the specifications of the target IC design. If it is determined that the functional blocks satisfactorily meet the specifications for the IC design, then a layout description for the functional circuit block is generated at step 309. The layout-level description is preferably in a format adept at describing graphical representations, such as, for example, Graphic Design System II (GDSII).

Further, a person skilled in the art would appreciate that said design objectives is not limited to IC design die size, die area, performance, power consumption, routability, fault tolerance, signal integrity, testability, reliability and cost etc or any combination thereof.

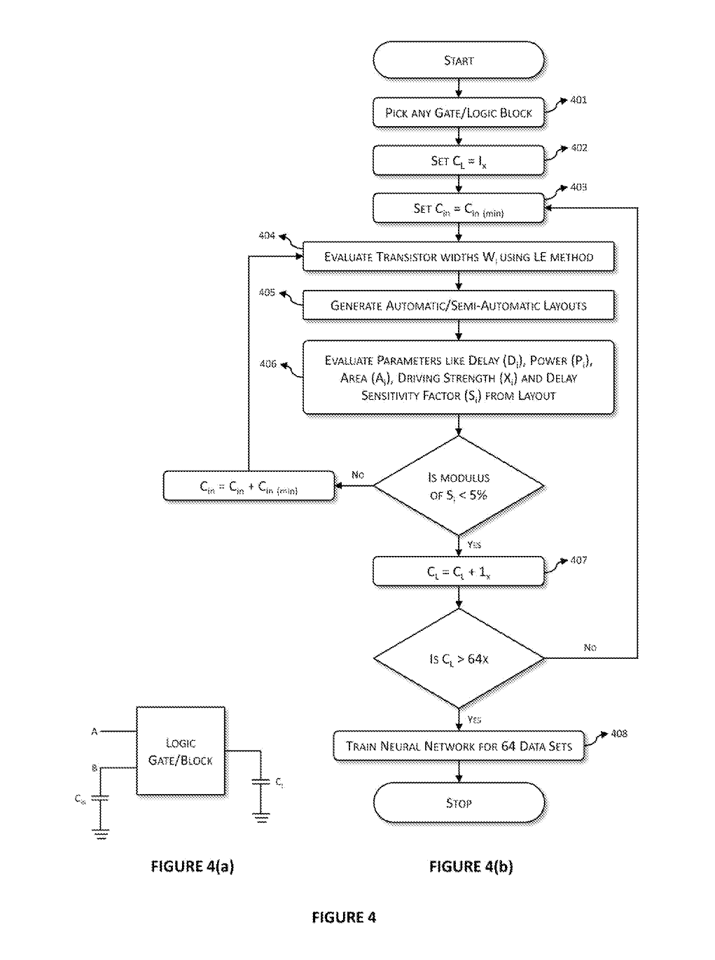

FIG. 4 illustrates the methodology for designing a neural network based configurable cell in accordance with the preferred embodiment of the present invention. Although the methodology is explained by choosing a simple gate as an example as shown in FIG. 4(a), the flow in general is applicable to any logic block with definite functionality. As a first step 401, pick up the gate to be implemented as a configurable neuro cell. The capacitive load to be driven by the gate is fixed at 1X, in step 402 (where X refers to the capacitance value corresponding to the input capacitance of a minimum sized inverter at a given process technology).

Further in step 403, input capacitance Cᵢₙ of the gate is initialized to minimum value Cᵢₙ(min) where Cᵢₙ(min) again represents the input capacitance of the minimum sized inverter at a given process technology. In step 404, transistor widths of said configurable neuro cell are evaluated using logical effort theory based on said load capacitance and input capacitance values. The widths of transistors obtained are used for generating automatic/semi-automatic layouts using tools like CELLERITY, in step 405. Various parameters like delay, power, area, driving strength and delay sensitivity factor etc. are extracted from layout using automation scripts (languages like Tcl in step 406. It is worth noting that any person skilled in the art would appreciate that any parameter related to circuit characterization although not included in step 406 also falls under the scope of the present invention. The steps 404-406 are repeated with existing Cᵢₙ value incremented by an amount Cᵢₙ in each iteration till the delay sensitivity factor is less than a value fixed by the designer (normally less than 10% or less, 5% in our case). For delay sensitivity factor less than 5%, the delay is assumed to be saturated for the given load and the load value is incremented by 1X in the next step 407 while the steps 403-406 are repeated till the gate is completely characterized for parameters listed in step 406 for loads varying from 1X-64X (or any other upper limit of capacitive load). The width values obtained in step 405 along with the parameters in step 406 are used for training a neural network in step 408. The neural network is trained such that the parameters listed in step 406 along with Ci are used as inputs while the width of transistors obtained in step 404 is used as outputs of the network. Moreover, those skilled in the art can appreciate that any other optimization methodology such as Levenberg-Marquradt algorithm or other soft-computing techniques (such as GA, PSO, ACO or any combination thereof) can be used for circuit characterization to extract parameters and relate them subsequently with transistor width through neural network based approach or any other soft computing technique or any combination thereof is within the spirit and scope of the invention.

According to an exemplary embodiment of the present invention, the entire process flow as described in FIG. 4 for designing a neural network based standard cell is divided into two phases:

(i) Cell Characterization Phase

(ii) Training Phase

Cell Characterization Phase:

Considering a two input GATE as shown in FIG. 4(a). Cᵢₙ is the input capacitance of the gate with respect to the input B, where Cᵢₙ is directly proportional to width of transistors connected to the input terminal. The relation between Cᵢₙ and transistor width is obtained through SPICE simulations at a given process technology:

Cᵢₙ=f(Width of transistors in a cell for a given input)

If width of transistors increases, the delay reduces but power dissipation and area of the cell increases in general. So width of transistors can't be increased indefinitely to satisfy timing constraints.

Further, the upper bound on the width of transistors for a cell is determined by delay sensitivity factor. Width is related to the input capacitance and as width increases Cᵢₙ also increases and delay reduces. As a result, the delay sensitivity factor is defined as differential of delay with Cᵢₙ:

$${S}_{D}^{{C}_{in}} - \frac{\partial D}{\partial {C}_{in}} \frac{{C}_{in}}{D} = - \frac{1}{N} \frac{t}{t + 1} \{ Derived from logical effort theory \}$$

When the value of S is such that its modulus is reduced below a target value (set by the library developer) 5% in our case the characterization is stopped further which implies that increasing Ci value and hence the width values has no considerable effect on cell delay reduction and the delay has saturated.

Thus, for a given C_{L} and Cᵢₙ, the absolute width of transistors is obtained using logical effort theory. Using these widths layout can be generated automatically using a layout generation tool such as “CELLERITY” to extract precise value of various parameters like Delay, Power, risetime, falltime etc. using automation scripts in scripting languages like Tel by generating the transistor level netlist from corresponding layout and exporting it to SPICE and the results are tabulated for a given load say 1X as shown in Table 1.

TABLE 1
Cell characterization for 1X capacitive load.

| | Set of Widths of | | Power | Power | | Driving |
|---|---|---|---|---|---|---|
| Cᵢₙ | transistors of the cell | Delay | total | leakage | Area | Strength |
| Cₘᵢₙ | W1 | D1 | P1 | Lp1 | A1 | M1 |
| 2Cₘᵢₙ | W2 | D2 | P2 | Lp2 | A2 | M2 |
| 3Cₘᵢₙ | W3 | D3 | P3 | Lp3 | A3 | M3 |
| 4Cₘᵢₙ | W4 | D4 | P4 | Lp4 | A4 | M4 |
| 5Cₘᵢₙ | W5 | D5 | P5 | Lp5 | A5 | M5 |
| 6Cₘᵢₙ | W6 | D6 | P6 | Lp6 | A6 | M6 |

The Cₘᵢₙ value in general can be any real valued number but at a given CMOS technology, this value is the input capacitance of a minimum sized CMOS inverter. The capacitive load 1X again is the capacitance value equal to the input capacitance value of a minimum sized inverter. Cₘᵢₙ specifies the lower bound on the process of cell characterization.

Another exemplary embodiment of cell characterization is shown in table 2.

TABLE 2

| Cᵢₙ (fF) | w1 | w2 | w3 | w4 | Delay (ps) | Power (uW) | PDP (fJ) |
|---|---|---|---|---|---|---|---|
| 2.48 | 2 | 2.35 | 2.79 | 6.65 | 226 | 554 | 125.2 |
| 4.96 | 4 | 3.95 | 3.95 | 7.91 | 191 | 585 | 111.7 |
| 7.44 | 6 | 5.35 | 4.84 | 8.76 | 173 | 599 | 103.6 |
| 9.92 | 8 | 6.65 | 5.59 | 9.41 | 166 | 615 | 102 |
| 12.4 | 10 | 7.86 | 6.25 | 9.95 | 162 | 632 | 102.3 |
| 14.8 | 12 | 9.01 | 6.85 | 10.4 | 159 | 648 | 103 |
| 17.3 | 14 | 10.1 | 7.40 | 10.8 | 157 | 665 | 104.4 |
| 19.8 | 16 | 11.1 | 7.91 | 11.2 | 155 | 675 | 104.6 |
| 22.3 | 18 | 12.2 | 8.39 | 11.5 | 154 | 682 | 105 |
| 24.8 | 20 | 13.2 | 8.84 | 11.8 | 153 | 689 | 105.4 |

The cell in this case has four set of transistors widths w1, w2, w3 and w4 corresponding to a Transmission Gate flip-flop wherein the width of individual transistors is normalized with respect to Wₘᵢₙ which represents the minimum width of a transistor at a given technology. Table 2 shows the variation of delay with increasing Cᵢₙ values. It is to be noted that the delay saturates at 153 ps for Cᵢₙ=24.8 fF. This leads to the determination of upper bound on transistor widths early in the design phase and hence defines the limits of power (energy)-delay design space. The table also lists the corresponding power measured along with the power-delay product. It is readily observed that minimum power-delay product is obtained at Cᵢₙ=9.92 fF. This process is repeated for capacitive load values upto NX where N is a real number with value an assumed value of 64 according to the present invention. Thus, there will be 64 set of data values similar to the ones as in Table 1 for a range of capacitive loads.

Training Phase:

The 64 set of data values is used to train a neural network with Cᵢₙ, delay, power, leakage power, risetime, falltime and most importantly driving strength as input values and widths of transistors as output values.

After training, the obtained neural network represents an intelligent configurable neuro cell corresponding to a given functionality (such as a 2-input NAND gate) covering the entire power-delay-area design space in entirety and absolute continuity with no discretization such that for any arbitrary driving strength (or any other arbitrary input parameter value) the corresponding width of transistors is generated by using a neural network simulation tool. The obtained set of transistor widths (or any circuit characterization parameter or a combination thereof) are then used to automatically/semi-automatically generate the layouts which represents the actual standard cell with specific circuit characteristics. Layout generation can be manual as well without deviating from the spirit and scope of the invention.

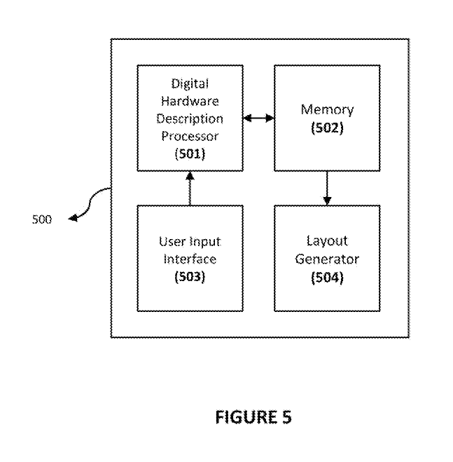

FIG. 5 illustrates a system configuration in accordance with the present invention. A system 500 for designing an integrated circuit comprising a digital hardware description processor 501, a memory 502 coupled to said processor 501, and a user input interface 503 coupled to said processor 501, said hardware description processor being operative to create an optimized cell library, wherein said cell library comprising a configurable cell for implementing a logic function; wherein said configurable cell is capable of implementing plurality of standard cells; wherein said configurable cell is characterized with a drive strength which varies with the input capacitance and/or output load capacitance of the circuit; wherein said drive strength is generated dynamically by evaluating a set of basic attributes of said cell from a set of input values derived from design goals for said integrated circuit; b) a layout generator 504 coupled to said digital hardware description to generate an integrated circuit design layout based on a set of output circuit parameter derived from the drive strength of said cell.

In an advantageous embodiment, the disclosed methodology according to the present invention provides an improved specification for designers which are described more efficiently using HDL language. Further, this allows achieving an improved logic synthesis technique, floor planning, placement and routing. Thus, the disclosed methodology fills the wide gap between ASIC design and Full Custom design which is a critical issue with the conventional CAD tools.

Further, those skilled in the art will appreciate that the scope of the invention is not limited to only digital applications of a transistor but also to the synthesis of systems using analog circuits and mixed signal blocks. The analog and mixed signal blocks in turn can be synthesized using the disclosed methodology based on neural network with a different set of parameters like gain, bandwidth, noise margin, phase margin and transistor widths, input capacitance, load capacitance etc. Moreover, said neural network based technique, used for synthesis of an integrated circuit, can be utilized in general for synthesizing any electronic circuit or system with definite functionality whose electrical behavior/characteristics can be modeled in terms of some input and output parameters which are used for subsequently training said neural network.

The present disclosure is applicable to all types of transistors used in various in digital electronic circuitry, such as FinFets, BJTs, MOSFETs or any other class of transistors used thereof.

The present disclosure is applicable to all types of on-chip and off chip memories used in various in digital electronic circuitry, or in hardware, firmware, or in computer hardware, firmware, software, or in combination thereof. Apparatus of the invention can be implemented in a computer program product tangibly embodied in a machine-readable storage device for execution by a programmable processor; and methods actions can be performed by a programmable processor executing a program of instructions to perform functions of the invention by operating on input data and generating output. The invention can be implemented advantageously on a programmable system including at least one input device, and at least one output device. Each computer program can be implemented in a high-level procedural or object-oriented programming language or in assembly or machine language, if desired; and in any case, the language can be a compiled or interpreted language.

Suitable processors include, by way of example, both general and specific microprocessors. Generally, a processor will receive instructions and data from a read-only memory and/or a random access memory. Generally, a computer will include one or more mass storage devices for storing data file; such devices include magnetic disks and cards, such as internal hard disks, and removable disks and cards; magneto-optical disks; and optical disks. Storage devices suitable for tangibly embodying computer program instructions and data include all forms of volatile and non-volatile memory, including by way of example semiconductor memory devices, such as EPROM, EEPROM, and flash memory devices; magnetic disks such as internal hard disks and removable disks; magneto-optical disks; CD-ROM and DVD-ROM disks; and buffer circuits such as latches and/or flip flops. Any of the foregoing can be supplemented by, or incorporated in ASICs (application-specific integrated circuits), FPGAs (field-programmable gate arrays) and/or DSPs) digital signal processors).

It will be apparent to those having ordinary skill in this art that various modifications and variations may be made to the embodiments disclosed herein, consistent with the present disclosure, without departing from the spirit and scope of the present disclosure. Other embodiments consistent with the present disclosure will become apparent from consideration of the specification and the practice of the description disclosed herein.

We claim:

1. A method for designing an integrated circuit, the method comprising:
(a) creating an optimized cell library, wherein said cell library comprising a configurable cell for implementing a logic function;
wherein said configurable cell is capable of implementing plurality of standard cells;
wherein said configurable cell is characterized with a drive strength which varies with the input capacitance and/or output load capacitance of the circuit;
wherein said drive strength is generated dynamically by evaluating a set of basic attributes of said cell from a set of input values derived from design goals for said integrated circuit;
(b) generating an integrated circuit design layout based on a set of output circuit parameters derived from the drive strength of said cell.

2. The method as claimed in claim 1, wherein said basic attribute is a delay sensitivity factor.

3. The method as claimed in claim 2, wherein said delay sensitivity factor is the differential of delay with respect to input pin capacitance.

4. The method as claimed in claim 2, wherein said delay sensitivity factor is derived from logical effect theory.

5. The method as claimed in claim 1, wherein said output circuit parameters are such as transistor width, power, area, output rising/falling delays and like.

6. A system (500) for designing an integrated circuit comprising:
(a) a digital hardware description processor (501), a memory (502) coupled to said processor (501), and a user input interface (503) coupled to said processor (501), said hardware description processor being operative to create an optimized cell library, wherein said cell library comprising a configurable cell for implementing a logic function;
wherein said configurable cell is capable of implementing plurality of standard cells;
wherein said configurable cell is characterized with a drive strength which varies with the input capacitance and/or output load capacitance of the circuit;
wherein said drive strength is generated dynamically by evaluating a set of basic attributes of said cell from a set of input values derived from design goals for said integrated circuit;
b) a layout generator (504) coupled to said digital hardware description to generate an integrated circuit design layout based on a set of output circuit parameters derived from the drive strength of said cell.

7. The system as claimed in claim 6, wherein said basic attribute is a delay sensitivity factor.

8. The system as claimed in claim 7, wherein said delay sensitivity factor is the differential of delay with respect to input pin capacitance.

9. The system as claimed in claim 7, wherein said delay sensitivity factor is derived from logical effect theory.

10. The system as claimed in claim 6, wherein said output circuit parameters are such as transistor width, power, area, output rising/falling delays and like.
